(19) United States
(12) Patent Application Publication
(10) Pub. No.: US 2021/0349461 A1
(43) Pub. Date: Nov. 11, 2021

(54) UNMANNED AERIAL VEHICLE, METHOD FOR CONTROLLING UNMANNED AERIAL VEHICLE, CONTROL APPARATUS, AND COMPUTER-READABLE STORAGE MEDIUM

(71) Applicant: SZ DJI TECHNOLOGY CO., LTD., Shenzhen (CN)

(72) Inventor: Yang LI, Shenzhen (CN)

(73) Assignee: SZ DJI TECHNOLOGY CO., LTD., Shenzhen (CN)

(21) Appl. No.: 17/204,865

(22) Filed: Mar. 17, 2021

Related U.S. Application Data
(63) Continuation of application No. PCT/CN2018/106565, filed on Sep. 19, 2018.

(51) Int. Cl. G05D 1/00; G05D 1/10; B64D 47/08; B64C 39/02; H04N 7/18; H04N 5/232

(52) U.S. Cl. CPC G05D 1/0094; G05D 1/101; B64D 47/08; B64C 2201/127; H04N 7/18; H04N 5/23296; B64C 39/024

(57) ABSTRACT

An unmanned aerial vehicle, a method for controlling an unmanned aerial vehicle, a control apparatus, and a computer-readable storage medium are provided. A method for controlling an unmanned aerial vehicle includes: detecting whether a preset trigger event for determining impending interference between a lens and an obstacle near the lens occurs; and if no, controlling the lens to be in an extended state; or if yes, controlling the lens to be in a retracted state, to avoid interference between extension of the lens and the obstacle. In the method for controlling the unmanned aerial vehicle according to the present disclosure, a size of the lens may be reduced while optical zoom performance is achieved through extension and retraction of the lens and a photographing requirement is satisfied. In this way, a size of the unmanned aerial vehicle is reduced, and portability of the unmanned aerial vehicle is greatly improved.

### RELATED APPLICATIONS

The present patent document is a continuation application of PCT Application Serial No. PCT/CN2018/106565, filed on Sep. 19, 2018, designating the United States and published in Chinese, content of which is herein incorporated by reference in its entirety.

### BACKGROUND

### 1. Technical Field

The present disclosure relates to the field of unmanned aerial vehicles, and more specifically, to an unmanned aerial vehicle, a method for controlling an unmanned aerial vehicle, a control apparatus, and a computer-readable storage medium.

### 2. Background Information

For a camera with an optical zoom lens, to adjust a focal length of the camera, a distance between a photographed object and a lens assembly needs to be changed, which means that the lens needs to have enough space to allow the movement of the lens assembly. Therefore, the length of the optical zoom lens of the camera may be large.

For an unmanned aerial vehicle for aerial photographing, it is required that a gimbal and a camara should not interfere with each other, which means that the size of the gimbal is affected by the size of the camera. In other words, the size of the camera affects the size of the gimbal, and the size and a moving range of the gimbal further affect the size of the entire unmanned aerial vehicle for aerial photographing. However, the smaller the camera is, the less interference the camera may cause, and the more compact the structure of the gimbal is. On the contrary, the larger the camera is, the more interference the camera may cause, and the structure of the gimbal needs to be.

Therefore, an optical zoom lens may need to be well controlled, so as to improve the compactness of the structure of the gimbal or the unmanned aerial vehicle.

### BRIEF SUMMARY

The present disclosure aims to at least solve the technical problems existing in the conventional technique.

According to some exemplary embodiments of the present disclosure, a method for controlling an unmanned aerial vehicle is disclosed. The method includes: determining whether a preset trigger event indicating impending interference between a lens of a photographing apparatus and an obstacle near the lens occurs, the photographing apparatus being disposed on a body of the unmanned aerial vehicle; and controlling the lens to be in an extended state in response to a determining that the preset trigger event does not occur; or controlling the lens to be in a retracted state, to avoid the lens from interfering with the obstacle, in response to a determining that the preset trigger event occurs

According to some exemplary embodiments of the present disclosure, a control apparatus for an unmanned aerial vehicle is disclosed. The unmanned aerial vehicle includes a body, a photographing apparatus located on the body; and a lens of the photographing apparatus extendable and retractable relative to the body. The control apparatus includes: at least one storage medium, storing at least one set of instructions for controlling the unmanned aerial vehicle; and at least one processor in communication with the at least one storage medium, wherein during operation, the at least one processor executes the at least one set of instructions to: determine whether a preset trigger event for determining impending interference between the lens and an obstacle near the lens occurs; and control the lens to be in an extended state in response to a determination that the preset trigger event does not occur; or control the lens to be in a retracted state, to avoid interference between extension of the lens and the obstacle, in response to a determination that the preset trigger event occurs.

According to some exemplary embodiments of the present disclosure, an unmanned aerial vehicle is disclosed. The unmanned aerial vehicle includes: a body; a photographing apparatus located on the body; a lens of the photographing apparatus extendable and retractable relative to the body; and a control apparatus, including: at least one storage medium, storing at least one set of instructions for controlling the unmanned aerial vehicle; and at least one processor in communication with the at least one storage medium, wherein during operation, the at least one processor executes the at least one set of instructions to: determine whether a preset trigger event for determining impending interference between the lens and an obstacle near the lens occurs; and control the lens to be in an extended state in response to a determination that the preset trigger event does not occur; or control the lens to be in a retracted state, to avoid interference between extension of the lens and the obstacle, in response to a determination that the preset trigger event occurs.

In exemplary embodiments of the present disclosure, by detecting the occurrence of a preset trigger event, the lens may be controlled to be in an extended state when the preset trigger event does not occur, so that the shooting device may perform operations such as high-power optical zoom to meet shooting requirements. In addition, when a preset trigger event occurs, the lens may be controlled to be in a retracted state to avoid interference with obstacles and being damaged. Furthermore, controlling the lens to retract may reduce the size of the drone, which may improve not only the portability and transportability of the drone, but also the stable control of the gimbal (also known as Pan-tilt-zoom, or PTZ) when the high-power optical zoom is not required. Therefore, under the premise of realizing optical zoom, the structure of the drone may be more compact.

The additional aspects and advantages of the exemplary embodiments of the present disclosure will become apparent in the following description, or be understood through the practice of the present disclosure.

### BRIEF DESCRIPTION OF THE DRAWINGS

The foregoing and/or additional aspects and advantages of the present disclosure will become more apparent and understandable in descriptions of the exemplary embodiments in combination with the accompanying drawings.

FIG. 1 is a schematic structural diagram of an unmanned aerial vehicle according to exemplary embodiments of the present disclosure;

FIG. 2 is a schematic flowchart of a method for controlling an unmanned aerial vehicle according to exemplary embodiments of the present disclosure;

FIG. 3 is a schematic flowchart of a method for controlling an unmanned aerial vehicle according to exemplary embodiments of the present disclosure;

FIG. 4 is a schematic flowchart of a method for controlling an unmanned aerial vehicle according to exemplary embodiments of the present disclosure;

FIG. 5 is a schematic flowchart of a method for controlling an unmanned aerial vehicle according to exemplary embodiments of the present disclosure;

FIG. 6 is a schematic block diagram of a control apparatus according to exemplary embodiments of the present disclosure; and

FIG. 7 is a schematic structural diagram of an unmanned aerial vehicle according to exemplary embodiments of the present disclosure.

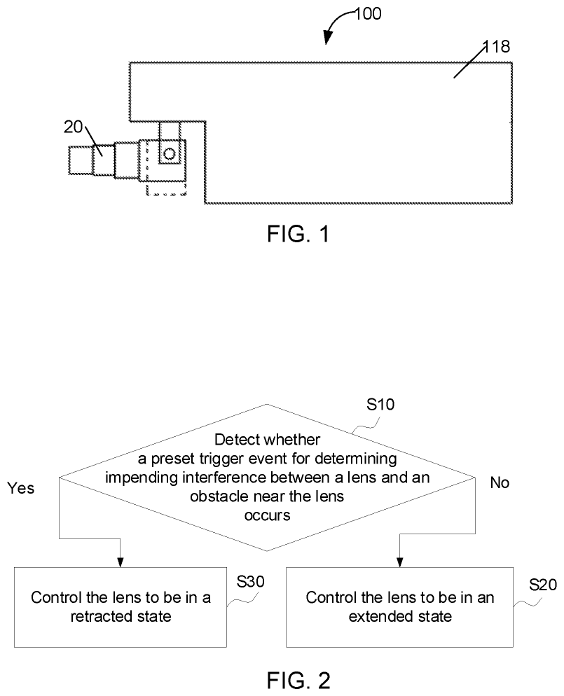

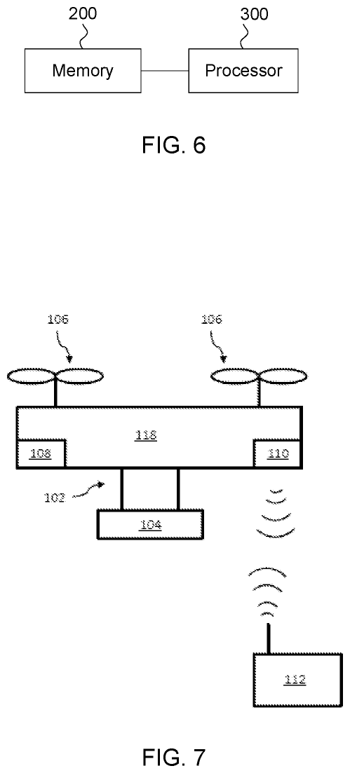

A correspondence between reference numerals and names of components in FIG. 1, FIG. 6, and FIG. 7 is as follows: 100: unmanned aerial vehicle; 102: gimbal; 104: photographing apparatus; 106: propeller; 108: controller; 110: sensing system; 112: control terminal; 118: body; 20: lens; 200: memory; and 300: processor.

### DETAILED DESCRIPTION OF THE DRAWINGS

The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the invention in this application in accordance with the embodiments of the present application. Therefore, the embodiments of the present application are not limited to those embodiments that have been precisely described in this disclosure.

To make the objective, features, and advantages of the present disclosure more comprehensible, the following further describes the present disclosure in detail with reference to accompanying drawings and specific embodiments. It should be noted that under a condition that no conflict occurs, the embodiments of this application and features in the embodiments may be mutually combined.

A plurality of specific details is described in the following description for fully understanding the present disclosure. However, the present disclosure may be further implemented in other manners different from the manner described herein. Therefore, the protection scope of the present disclosure is not limited by the following disclosed specific embodiments.

With reference to the accompanying drawings, the following describes a method for controlling an unmanned aerial vehicle, a control apparatus, an unmanned aerial vehicle, and a computer-readable storage medium according to some exemplary embodiments of the present disclosure.

As shown in FIG. 1, an unmanned aerial vehicle 100 may include a body 118 and a photographing apparatus located on the body 118. The photographing apparatus may be directly connected to the body 118 or indirectly connected to the body 118 using an intermediate connection member. The intermediate connection member may include but is not limited to a gimbal. The photographing apparatus may include a lens 20, and the lens 20 may be extended and retracted relative to the body 118. A dashed line box shown in FIG. 1 may indicate the lens in a retracted state. For example, when the unmanned aerial vehicle is undeployed and to be carried by a person, the retraction of the lens may reduce the size of the unmanned aerial vehicle, thereby improving the compactness of the unmanned aerial vehicle.

When the lens is in an extended state, high-magnification optical zoom may be realized. When the lens is in the retracted state, low-magnification optical zoom may be realized. In some exemplary embodiments, the photographing apparatus may also have a digital zoom function to satisfy different photographing requirements.

In the one or more methods for controlling an unmanned aerial vehicle according to exemplary embodiments of the present disclosure, by detecting whether a preset trigger event for determining an impending interference between a lens and any nearby obstacle occurs, and controlling the extension and retraction of the lens based on the result of the detection, the size of the lens and the volume of the unmanned aerial vehicle may be adjusted based on a requirement while optical zoom performance is achieved and a photographing requirement is satisfied. In this way, the portability of the unmanned aerial vehicle is greatly improved.

As shown in FIG. 2, a method for controlling an unmanned aerial vehicle according to some exemplary embodiments of the present disclosure may include the following step(s).

Step S10: detecting whether a preset trigger event for determining that impending interference between a lens and an obstacle near the lens occurs.

In some exemplary embodiments, when the unmanned aerial vehicle carries a photographing apparatus with an optical zoom function, a lens of the photographing apparatus may be extended and retracted relative to a body. The preset trigger event may be set in advance, to avoid lens damage caused by the interference between the lens and the obstacle when the lens is extended or retracted in optical zoom during a photographing process of the photographing apparatus. The preset trigger event may be used for determining an impending interference(s) between the lens of the photographing apparatus and the obstacle near the lens. For example, if the preset trigger event occurs, it means that an interference may occur between the lens of the photographing apparatus and the obstacle near the lens, and extension of the lens or an extension length of the lens needs to be controlled based on a policy; otherwise, it means that the lens of the photographing apparatus is safe, and it may be considered by default that the lens will not interfere with the obstacle near the lens at least before next detection of whether the preset trigger event occurs, and the lens may be randomly extended or retracted as necessary.

The obstacle near the lens may be an obstacle that may interfere with the lens and cause lens damage when the lens is extended relative to the body in a current state of the photographing apparatus, or may be an obstacle that may cause the lens to interfere with another obstacle and thus cause lens damage. Therefore, the obstacle may be an obstacle on an extension line of a current extension direction of the lens, or may be an obstacle on an extension line of a direction at any angle to a current extension direction of the lens.

In some exemplary embodiments, the obstacle may include an obstacle below in a vertical direction in a current state of the unmanned aerial vehicle. The obstacle below may include an obstacle below the lens in the vertical direction in the current state and/or an obstacle below the body in the vertical direction in the current state. For example, the obstacle may cause the lens to directly interfere with the obstacle (for example, in this case, the lens is extended downward in the vertical direction), or may cause the lens to interfere with another obstacle than the obstacle (for example, in this case, the lens is not extended downward in the vertical direction, and another obstacle exists on the extension line of the extension direction of the lens).

In addition to downward extension, the lens may be rotated relative to the body in a horizontal plane, a vertical plane, or a plane between a horizontal plane and a vertical plane under action of an intermediate connection member such as a gimbal (or an orientation of the lens may change because a posture change of the unmanned aerial vehicle causes a posture change of the directly connected photographing apparatus). Therefore, when the lens is extended relative to the body, the extension direction of the lens is not necessarily vertically downward. Therefore, In some exemplary embodiments, the obstacle may further include an obstacle in the extension direction of the lens in the current state of the unmanned aerial vehicle. Therefore, when being extended or in an extended state, the lens may be directly prevented from interfering with the obstacle on the extension line of the extension direction.

Depending on an environment in which the unmanned aerial vehicle and the lens are located, non-limiting examples of the obstacle may be the ground, or may be a stone or table on the ground, or may be a building or the like.

For example, a control apparatus configured to perform the method for controlling the unmanned aerial vehicle may periodically perform step S10, or may irregularly (e.g., aperiodically) perform step S10. For example, when the optical zoom function needs to be used for photographing or rotation of a propeller of the unmanned aerial vehicle is detected, step S10 may be started. For another example, in a case in which a gimbal is mounted on the body, step S10 may be started when the gimbal is powered on.

It may be understood that the preset trigger event in this embodiment may be set before the unmanned aerial vehicle is delivered from the factory, that is, the setting is a factory setting of the unmanned aerial vehicle, or the preset trigger event may be set by a user.

If the preset trigger event does not occur, step S20 may be performed to control the lens to be in the extended state.

In some exemplary embodiments, when the preset trigger event does not occur, it means that extension of the lens may be safe. In this case, the lens may be controlled to be in the extended state to satisfy a photographing requirement of the photographing apparatus under an optical zoom condition.

The extended state is a state in which the lens is extended relative to the body.

It may be understood that when the lens is in the extended state, the extension length of the lens may be limited based on a requirement, or may not be limited based on a requirement.

If the preset trigger event occurs, step S30 is performed to control the lens to be in a retracted state, to avoid interference between extension of the lens and the obstacle.

In some exemplary embodiments, when the preset trigger event occurs, it means that extension of the lens will probably causes interference between the lens and the obstacle. In this case, the lens may be controlled to be in the retracted state to avoid interference between the lens and the obstacle.

The retracted state is a state in which the lens is retracted relative to the body. In some exemplary embodiments where the lens has one extension length relative to the body, the retracted state may be a state in which the lens is completely retracted relative to the body. In some exemplary embodiments where the lens has a plurality of extension lengths relative to the body, the retracted state may be a state in which the lens is completely retracted relative to the body, or a state in which the lens is not completely retracted but only partially retracted relative to the body (that is, in comparison with the current state, the extension length is reduced). A specific extended or retracted state may be controlled as required.

It may be understood that regardless of whether the lens is in a completely retracted state or a partially retracted state, the extended or retracted state of the lens should not cause interference between the lens and the obstacle in this case.

In some exemplary embodiments, extension or retraction of the lens may be controlled by detecting whether the preset trigger event occurs, so that the state of the lens (extended or retracted) may correspond to a detection result of the preset trigger event. Therefore, when high-magnification optical zoom may be required and extension of the lens will not interfere with the obstacle, extension of the lens may be controlled to change a focal length of the photographing apparatus to satisfy a photographing requirement. When an impending interference may occur during the storage or transportation of the unmanned aerial vehicle, or between the extended lens and the obstacle, the lens may be controlled to be completely or partially retracted, so that lens damage caused by interference between the extension of the lens and the obstacle may be avoided. The volume of the unmanned aerial vehicle may also be reduced while optical zoom is implemented. The retraction of the lens facilitates transportation of the unmanned aerial vehicle, reduces transportation cost, reduces carrying effort by the user, and enhances the portability of the unmanned aerial vehicle.

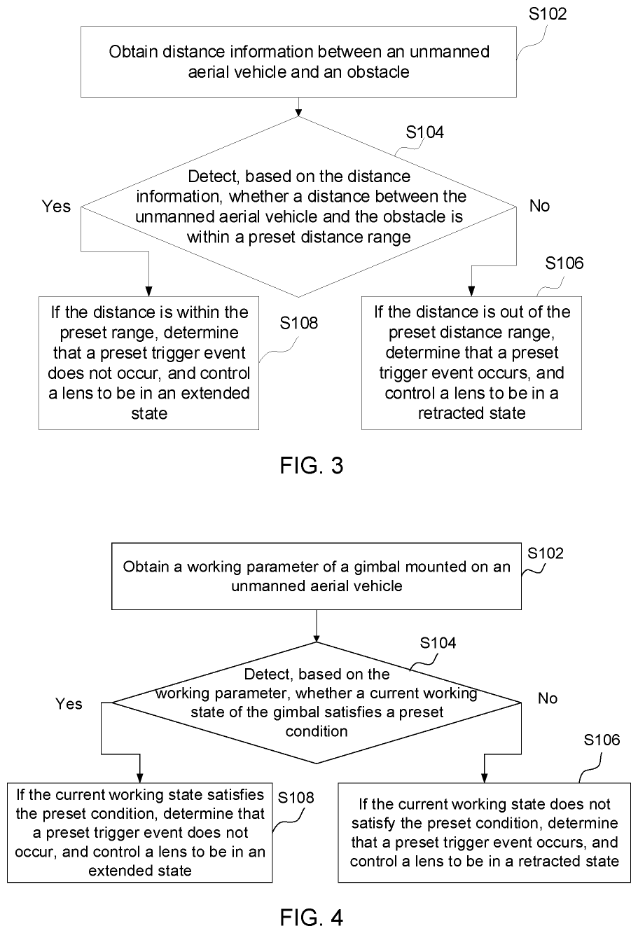

The exemplary embodiments, as shown in FIG. 3, indicate that step S10 of detecting whether a preset trigger event for determining impending interference between a lens and an obstacle near the lens occurs may further include step S102, step S104, step S106, and step S108, according to some exemplary embodiments of the present disclosure.

Step S102: Obtain distance information between the unmanned aerial vehicle and the obstacle.

In some exemplary embodiments, the photographing apparatus may be mounted on the body of the unmanned aerial vehicle, and a relative position relationship between the photographing apparatus and the body of the unmanned aerial vehicle is relatively fixed. Therefore, a distance between the lens and the obstacle may be determined by detecting a distance between the unmanned aerial vehicle and the obstacle. Therefore, the distance information may be used for determining whether the preset trigger event occurs, and further determine whether the lens extended will hit the obstacle.

For example, the distance information may be obtained using a ranging sensor. The ranging sensor may include but is not limited to at least one of a binocular vision sensor, a time-of-flight TOF sensor, an ultrasonic ranging sensor, a laser ranging sensor, an infrared ranging sensor, a radar ranging sensor, or a sonar sensor.

Step S104: Detect, based on the distance information, whether a distance between the unmanned aerial vehicle and the obstacle is within a preset distance range. In some exemplary embodiments, the preset distance range may be set in advance, and the preset distance range may be used for determining a current distance between the unmanned aerial vehicle and the obstacle, to indicate whether the preset trigger event occurs, and further indicate whether the lens may interfere with the obstacle near the lens.

It may be understood that the preset distance range in this embodiment may be set before the unmanned aerial vehicle is delivered from the factory, that is, the setting may be a factory setting of the unmanned aerial vehicle, or the preset distance range may be set by the user.

Step S106: If the distance is out of (e.g., not within) the preset distance range, determine that the preset trigger event occurs, and control the lens to be in the retracted state.

In some exemplary embodiments, when the distance between the unmanned aerial vehicle and the obstacle is out of (e.g., not within) the preset distance range, it may be determined that the preset trigger event occurs, and the lens may interfere with the obstacle near the lens, and the lens may be controlled to be in the retracted state.

In some exemplary embodiments, the obstacle may be an obstacle below the unmanned aerial vehicle and that the preset distance range may be a range that is greater than 5 meters. When the distance between the obstacle and the unmanned aerial vehicle is 5 meters or less than 5 meters, the preset trigger event occurs, and the lens may be controlled to be in the retracted state.

It may be understood that for obstacles in different positions relative to the unmanned aerial vehicle, preset distance ranges corresponding to the obstacles may be different. In some exemplary embodiments, a preset distance range corresponding to an obstacle below the unmanned aerial vehicle may be different from a preset distance range corresponding to an obstacle in the extension direction of the lens in the current state of the unmanned aerial vehicle. In addition, for different types of obstacles, the preset distance ranges corresponding the obstacles, for example, a preset distance range corresponding to an animate obstacle and a preset distance range corresponding to an inanimate obstacle, may also be different. Therefore, the extension and extension length of the lens may be controlled depending on different scenes. This is more advantageous for satisfying different photographing requirements.

Step S108: If the distance is within the preset range, determine that the preset trigger event does not occur, and control the lens to be in the extended state.

In some exemplary embodiments, when the distance between the unmanned aerial vehicle and the obstacle is within the preset distance range, it may be determined that the preset trigger event does not occur, and the lens may not interfere with the obstacle near the lens. In this case, the lens may be controlled to be in the extended state.

For example, it may be assumed that the obstacle is an obstacle below the unmanned aerial vehicle and that the preset distance range may be a range that is greater than 5 meters. When the distance between the obstacle and the unmanned aerial vehicle is 6 meters, the preset trigger event does not occur, and the lens may be controlled to be in the retracted state.

In some exemplary embodiments, when the distance between the unmanned aerial vehicle and the obstacle is long and the distance is within the preset distance range, it may be determined that extension of the lens will not interfere with the obstacle. In this case, the lens may be controlled to be in the extended state. When the distance between the unmanned aerial vehicle and the obstacle is short and the distance is out of (e.g., not within) the preset distance range, it may be considered by default that extension of the lens is to interfere with the obstacle. In this case, the lens may be controlled to be in the retracted state, so that the lens is prevented from hitting the obstacle and being damaged by the obstacle. In addition, the distance information between the unmanned aerial vehicle and the obstacle is used for determining whether extension of the lens may interfere with the obstacle. This method is simple and reliable, with a low implementation cost.

When the obstacle is an obstacle below in the vertical direction in the current state of the unmanned aerial vehicle, extension or retraction of the lens is controlled based on the distance between the obstacle and the unmanned aerial vehicle. When the distance between the obstacle and the unmanned aerial vehicle is within the preset distance range, that is, a safe distance, the lens of the photographing apparatus may be controlled to adjust the orientation and extension of the lens arbitrarily based on a requirement, to satisfy a photographing requirement such as high-magnification optical zoom. In some exemplary embodiments, the control method may be applied to a state in which the unmanned aerial vehicle leaves the ground (that is, leaving a take-off platform, such as the ground). For example, the control method may be used for controlling extension or retraction of the lens in a flying state or a returning state. Certainly, in the returning state, the lens may also be controlled to be in the retracted state. In some exemplary embodiments, different scenes may be controlled based on a requirement.

In some exemplary embodiments, when the obstacle may be an obstacle below the unmanned aerial vehicle, it means that the unmanned aerial vehicle has left the ground and is in the flying state. Therefore, before step S104, the method may further include a step of detecting whether the propellers of the unmanned aerial vehicle are rotating. If the propellers are rotating, the unmanned aerial vehicle is about to leave the ground or has left the ground and is in the flying state, and the unmanned aerial vehicle may have a non-zero flying height. In this case, step S104 may be performed. If the propellers are not rotating, then the unmanned aerial vehicle has not left the ground (or the unmanned aerial vehicle is not started; for example, the unmanned aerial vehicle is placed on a hand but has a certain height relative to the ground), step S104 may not be performed. It may be understood that the step of detecting whether the propellers are rotating may occur before or after the foregoing step S102.

Whether the propellers are rotating may be determined by detecting whether a controller issues an instruction for controlling rotation of the propellers or detecting a working state of a motor that drives rotation of the propellers.

In some exemplary embodiments, when the propellers are not rotating, the lens may not be extended, and only operations including, but not limited to, focusing, small-range zoom, or digital zoom may be performed. When the propellers are rotating and a flying height of the unmanned aerial vehicle higher than a certain level is detected (for example, the distance between the unmanned aerial vehicle and the ground is within the preset distance range), a wide-range optical zoom operation may be performed, and the lens may be extended. When the propellers are rotating and the height lower than a certain level is detected (for example, the distance between the unmanned aerial vehicle and the ground is out of (e.g., not within) the preset distance range), the lens may be retracted to limit a wide-range optical zoom function.

In this way, the current state of the unmanned aerial vehicle is determined by detecting whether the propellers are rotating. When the unmanned aerial vehicle leaves the ground and has a certain flying height, extension or retraction of the lens may be controlled based on the obtained distance information between the unmanned aerial vehicle and the obstacle. This may not only satisfy the photographing requirement but also may prevent the lens from colliding with the obstacle and being damaged. However, when the propellers are not rotating, that is, when the unmanned aerial vehicle has not left the ground, the lens is controlled to be in the retracted state. This may prevent the lens from being extended and colliding with the obstacle (especially the ground), which otherwise causes lens damage.

Alternative to FIG. 3, on the basis of the exemplary embodiments shown in FIG. 2, FIG. 4 shows that step S10 of detecting whether a preset trigger event for determining impending interference between a lens and an obstacle near the lens occurs may further include step S102, step S104, step S106, and step S108.

Step S102: Obtain a working parameter of a gimbal mounted on the unmanned aerial vehicle.

In some exemplary embodiments, the unmanned aerial vehicle may further include the gimbal and a driving apparatus. The gimbal is disposed on the body. The lens is disposed on the gimbal, and may be extended and retracted relative to the gimbal. The driving apparatus is connected to the gimbal, and may be configured to drive the gimbal to move relative to the body. The gimbal may be a single-axis gimbal, a dual-axis gimbal, or a three-axis gimbal, and may be configured to rotate around at least one axis, to achieve stabilization of the photographing apparatus on the gimbal or adjustment of a shooting angle. The driving apparatus may include but is not limited to a motor. In some exemplary embodiments, the motor may be a brushless motor.

When the photographing apparatus is disposed on the gimbal, the lens may not only be extended or retracted relative to the body, but also may move with the gimbal relative to the body. Therefore, whether extension of the lens will interfere with the obstacle may be determined using the working parameter of the gimbal.

The working parameter of the gimbal may include but not limited to a posture parameter of the gimbal and/or a driving parameter of the driving apparatus of the gimbal. For example, on one hand, because the photographing apparatus and the gimbal are relatively fixed, a posture of the gimbal may determine a posture of the photographing apparatus, and the extension direction of the lens is related to the posture parameter of the gimbal. Therefore, to detect whether the lens may interfere with the obstacle near the lens, the posture parameter of the gimbal may be obtained. On the other hand, when the obstacle exists, the obstacle may block motion of the gimbal. When facing resistance, the gimbal may use a driving parameter different from that in normal working of the gimbal. Therefore, to detect whether the lens is to interfere with the obstacle near the lens, the driving parameter of the driving apparatus may be obtained.

Step S104: Detect, based on the working parameter, whether a current working state of the gimbal satisfies a preset condition.

In some exemplary embodiments, the preset condition may be set in advance, and the preset condition may be used for determining the current working state of the gimbal, to indicate whether the preset trigger event occurs, and further indicate whether the lens may interfere with the obstacle near the lens.

It may be understood that the preset condition according to some exemplary embodiments may be set before the unmanned aerial vehicle is delivered from the factory, that is, the setting may be a factory setting of the unmanned aerial vehicle, or the preset condition may be set by the user.

Step S106: If the current working state does not satisfy the preset condition, determine that the preset trigger event occurs, and control the lens to be in the retracted state.

In some exemplary embodiments, when the current working state of the gimbal does not satisfy the preset condition, it may be determined that the preset trigger event occurs, and the lens may interfere with the obstacle near the lens. In this case, the lens may be controlled to be in the retracted state.

Step S108: If the current working state satisfies the preset condition, determine that the preset trigger event does not occur, and control the lens to be in the extended state.

In some exemplary embodiments, when the current working state of the gimbal satisfies the preset condition, it may be determined that the preset trigger event does not occur, and the lens may not interfere with the obstacle near the lens. In this case, the lens may be controlled to be in the extended state.

In some exemplary embodiments, whether the preset trigger event occurs may be determined based on the working parameter of the gimbal, to control extension or retraction of the lens. This may ensure that extension of the lens will not hit the obstacle and prevent the lens from being damaged by the obstacle. Further, when extension of the lens does not interfere with the obstacle, the lens may be controlled to be extended to satisfy the photographing requirement.

In some exemplary embodiments, step S104 of detecting, based on the working parameter, whether a current working state of the gimbal satisfies a preset condition may include: detecting, based on the posture parameter of the gimbal, whether a current posture of the gimbal is a preset posture.

In some exemplary embodiments, the gimbal may be a three-axis gimbal, the gimbal may be configured to rotate around a pitch axis, a roll axis, or a yaw axis. Correspondingly, the posture of the gimbal may include a posture corresponding to the pitch axis, a posture corresponding to the roll axis, or a posture corresponding to the yaw axis. In some exemplary embodiments, an IMU (inertial measurement unit) may be used for detecting the posture parameter of the gimbal, to determine the current posture of the gimbal. The IMU may include a gyroscope or an accelerometer.

The current posture of the gimbal may reflect the current posture of the photographing apparatus, so that whether extension of the lens of the photographing apparatus may interfere with the obstacle near the lens under the current posture of the gimbal may be estimated. For example, the obstacle may be an obstacle below the unmanned aerial vehicle, when the current posture of the photographing apparatus is horizontally forward, extension of the lens of the photographing apparatus may not interfere with the obstacle. If the obstacle is an obstacle in front of the photographing apparatus, such as a stone, when the current posture of the photographing apparatus is still horizontally forward, extension of the lens of the photographing apparatus may interfere with the obstacle, but if the current posture of the photographing apparatus is 45 degrees obliquely upward, extension of the lens of the photographing apparatus may not interfere with the obstacle. As may be known from this, the current posture of the gimbal may be used for estimating whether extension of the lens of the photographing apparatus is to interfere with the obstacle.

In some exemplary embodiments, the preset posture may be set in advance, and the preset posture may be used for determining the current posture of the gimbal to indicate whether the current working state of the gimbal satisfies the preset condition, and further indicate whether the preset trigger condition occurs, and indicate whether the lens may interfere with the obstacle near the lens. The preset posture may be one posture or a posture range including, but not limited to, a plurality of postures. When the current posture of the gimbal is not the preset posture, it may be determined that the current working state of the gimbal does not satisfy the preset condition. Conversely, when the current posture of the gimbal is the preset posture, it may be determined that the current working state of the gimbal satisfies the preset condition.

It may be understood that when the unmanned aerial vehicle is on the ground, the user may learn a current ground environment and may manually remove an obstacle that may interfere with the extension of the lens. In some exemplary embodiments, when whether extension of the lens of the photographing apparatus may interfere with the obstacle is estimated based on the current posture of the gimbal, the obstacle may be an obstacle below in the vertical direction in the current state of the unmanned aerial vehicle. Further, when the gimbal rotates around the pitch axis, a vertical pitch angle of the lens of the photographing apparatus may be directly affected. In some exemplary embodiments, the preset posture may be the posture corresponding to the pitch axis, that is, whether the current posture corresponding to the pitch axis of the gimbal conforms to a posture corresponding to the pitch axis in the preset posture may be detected.

In some exemplary embodiments, the posture parameter of the gimbal affects the extension direction of the lens. Therefore, extension or retraction of the lens may be controlled based on the posture parameter of the gimbal, and the lens may be prevented from being damaged by interference between extension of the lens and the obstacle. When the posture parameter of the gimbal may not cause the lens to interfere with the obstacle, extension of the lens may be controlled to implement high-magnification optical zoom or the like.

In some exemplary embodiments, step S104 of detecting, based on the working parameter, whether a current working state of the gimbal satisfies a preset condition may include: detecting whether the driving parameter is within a preset parameter range.

In some exemplary embodiments, the driving apparatus of the gimbal may be the motor, and the driving parameter of the driving apparatus may include but is not limited to a current of the motor or an output torque of the motor. When the gimbal interferes with the lens or an obstacle near the gimbal, lens damage may be caused due to interference between extension of the lens and the obstacle. When the gimbal interferes with the obstacle, the motor faces resistance, and the driving parameter of the motor may change. For example, when the gimbal interferes with an obstacle on the ground, such as a stone, an output current of the motor is larger than that of during normal stabilization. Therefore, the preset parameter range may be set in advance, and the preset parameter range may be used for determining the current driving parameter of the gimbal to indicate whether the current working state of the gimbal satisfies the preset condition, and further indicate whether the preset trigger condition occurs, and indicate whether the lens is to interfere with the obstacle near the lens. When the driving parameter is not within (e.g., out of) the preset parameter range, it may be determined that the current working state of the gimbal does not satisfy the preset condition. Conversely, when the driving parameter is within the preset parameter range, it is determined that the current working state of the gimbal satisfies the condition.

In some exemplary embodiments, when the gimbal or the lens interferes with the obstacle, the driving parameter of the driving apparatus of the gimbal changes. Therefore, whether the preset trigger event occurs may be determined based on the driving parameter, and extension or retraction of the lens may be controlled, to prevent the lens from being damaged by interference between extension of the lens and the obstacle. In addition, when the lens does not interfere with the obstacle, extension of the lens is controlled to implement high-magnification optical zoom.

In some exemplary embodiments, detecting whether the driving parameter is within a preset parameter range may further include: detecting whether the current of the motor is less than a preset current. When the gimbal or the lens interferes with the obstacle, the current flowing through the motor increases. Whether the gimbal or the lens interferes with the obstacle may be determined by detecting the current of the motor. Therefore, if the current of the motor is not less than the preset current, it is determined that the driving parameter is not within the preset parameter range (e.g., out of the preset parameter range), and the lens may be controlled to be in the retracted state. If the current of the motor is less than the preset current, it is determined that the driving parameter is within the preset parameter range, and the lens may be controlled to be in the extended state. In some exemplary embodiments, detecting whether the driving parameter is within a preset parameter range may include: detecting whether the output torque of the motor is less than a preset output torque. When the gimbal or the lens interferes with the obstacle, the output torque of the motor increases. Whether the gimbal or the lens interferes with the obstacle may be learned by detecting the output torque of the motor. Therefore, if the output torque of the motor is not less than the preset output torque, it is determined that the driving parameter is not within (e.g., out of) the preset parameter range, and the lens may be controlled to be in the retracted state. If the output torque of the motor is less than the preset output torque, it is determined that the driving parameter is within the preset parameter range, and the lens may be controlled to be in the extended state.

In some exemplary embodiments, it may also possible to simultaneously detect whether the current of the motor is less than the preset current and whether the output torque of the motor is less than the preset output torque. For example, when the current of the motor is less than the preset current, and the output torque of the motor is less than the preset output torque, it may be determined that the driving parameter is within the preset parameter range; otherwise, it is determined that the driving parameter is not within (e.g., out of) the preset parameter range. There may be no specific limitation herein.

In some exemplary embodiments, based on the current and/or output torque of the motor, whether the gimbal or the lens interferes with the obstacle may be determined. When the current is greater than or equal to the preset current and/or the output torque is greater than or equal to the preset torque, it may be determined that the gimbal or the lens interferes with an obstacle, and the lens may be controlled to be retracted to avoid lens damage. In addition, the volume of the gimbal may be reduced, which is advantageous for performing posture control on the gimbal. Conversely, it may be determined that the gimbal or the lens may not interfere with the obstacle, and the lens may be controlled to be extended to satisfy the photographing requirement.

In some exemplary embodiments, step S104 of detecting, based on the working parameter, whether a current working state of the gimbal satisfies a preset condition may include: detecting, based on the posture parameter of the gimbal, whether a current posture of the gimbal may be a preset posture, and detecting whether the driving parameter may be within a preset parameter range.

It may be understood that for the corresponding content in the present exemplary embodiment, reference may be made to the description of the foregoing exemplary embodiments. Details are not described again herein. When the current posture of the gimbal is not the preset posture, and the driving parameter of the gimbal is not within the preset parameter range, it may be determined that the current working state of the gimbal does not satisfy the preset condition, and the lens may be controlled to be in the extended state; otherwise, it may be determined that the current working state of the gimbal satisfies the preset condition, and the lens may be controlled to be in the retracted state.

As described above, the control method of the exemplary embodiment may be applied to a state when the gimbal is powered on, that is, the motor is not powered off or not sleeping. By obtaining the working parameter of the gimbal, whether the current state of the gimbal satisfies the preset condition may be detected, to determine whether the preset trigger event occurs, so that extension or retraction of the lens may be controlled. For example, when it is determined, based on the working parameter of the gimbal, that extension of the lens may not interfere with the obstacle, the lens may be controlled to be in the extended state to satisfy the photographing requirement of high-magnification optical zoom. When it is determined, based on the working parameter of the gimbal, that a current extension length or further extension of the lens may interfere with the obstacle, the lens may be controlled to be in the retracted state to avoid lens damage caused by collision between extension of the lens and the obstacle.

In some exemplary embodiments, the control method of this embodiment may be applied to a take-off-ready state (i.e., ready-to-take-off state) of the unmanned aerial vehicle. When the unmanned aerial vehicle is in the take-off-ready (i.e., ready-to-take-off state) state, the unmanned aerial vehicle has not left a takeoff platform (such as the ground), and the gimbal may be powered on. In this case, whether extension of the lens will interfere with the obstacle near the lens may be estimated by detecting the working parameter of the gimbal, so that extension or retraction of the lens may be controlled.

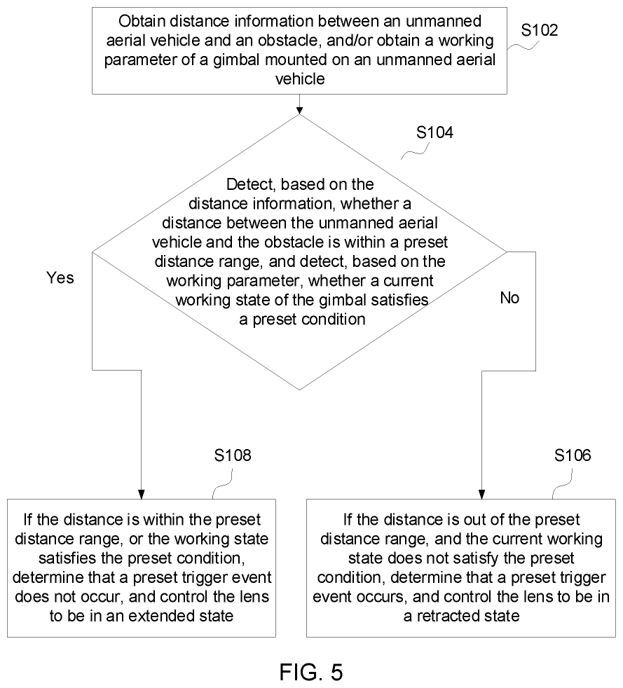

Alternative to FIG. 4, on the basis of the exemplary embodiments in FIG. 2, FIG. 5 shows that, step S10 of detecting whether a preset trigger event for determining impending interference between a lens and an obstacle near the lens occurs may further include step S102, step S104, step S106, and step S108.

Step S102: Obtain distance information between the unmanned aerial vehicle and the obstacle, and obtain a working parameter of a gimbal mounted on the unmanned aerial vehicle.

Step S104: Detect, based on the distance information, whether a distance between the unmanned aerial vehicle and the obstacle is within a preset distance range, and detect, based on the working parameter, whether a current working state of the gimbal satisfies a preset condition.

Step S106: If the distance is out of (e.g., not within) the preset distance range, and the current working state does not satisfy the preset condition, determine that the preset trigger event occurs, and control the lens to be in the retracted state.

Step S108: If the distance is within the preset distance range, or the working state satisfies the preset condition, determine that the preset trigger event does not occur, and control the lens to be in the extended state.

A method for obtaining the distance information and a method for performing detection using the distance information are the same as those described in the exemplary embodiments as shown in FIG. 3, and a method for obtaining the working parameter of the gimbal and a method for performing detection using the working parameter are the same as those described in the exemplary embodiments as shown in FIG. 4. Details are not described again herein.

A difference between the exemplary embodiments shown in FIG. 5 and the exemplary embodiments shown in FIG. 3 and FIG. 4 lies in that the distance information between the unmanned aerial vehicle and the obstacle and the working parameter of the gimbal need to be obtained; in addition, as long as the distance between the unmanned aerial vehicle and the obstacle is within the preset distance range or the working state of the gimbal satisfies the preset condition, it may be considered that the preset trigger event does not occur, and the lens may be controlled to be in the extended state to satisfy the photographing requirement of optical zoom as much as possible.

In the present exemplary embodiment, the distance between the unmanned aerial vehicle and the obstacle and the working parameter of the gimbal are jointly detected and are jointly used for determining whether extension of the lens may interfere with the obstacle. This enhances accuracy of controlling extension or retraction of the lens and further avoids lens damage caused by collision between extension of the lens and the obstacle.

In some exemplary embodiments, the control method of this embodiment may be applied to a state in which the unmanned aerial vehicle leaves the ground.

As described in the exemplary embodiments above, a condition for extension of the lens is that the extended lens will not interfere with the obstacle. For example, this may be determined on a basis that the distance between the unmanned aerial vehicle and the obstacle is within the preset range or that the flying height of the unmanned aerial vehicle is higher than a certain level, or may be determined on a basis that the gimbal has been powered on and that the working state of the gimbal satisfies the preset condition. A condition for retraction of the lens may be that the extended lens may interfere with the obstacle. For example, this may be determined on a basis that the distance between the unmanned aerial vehicle and the obstacle is out of (e.g., not within) the preset distance range or that the flying height of the unmanned aerial vehicle is lower than a certain level, or may be determined on a basis that the working state of the gimbal does not satisfy the preset condition.

A flying process of the unmanned aerial vehicle may include: a ground state, a take-off state, an aerial flying state, and a returning state.

In some exemplary embodiments, the method for controlling the unmanned aerial vehicle may include: before the unmanned aerial vehicle takes off, that is, when the unmanned aerial vehicle has not leave the ground (that is, when the unmanned aerial vehicle has not leave the take-off platform, such as the ground), the flying height of the unmanned aerial vehicle is zero. In this case, only the working parameter of the gimbal may be detected; and when it is determined, based on the working parameter of the gimbal, that the working state of the gimbal satisfies the preset condition, the lens may be controlled to be extended; or when it is determined, based on the working parameter of the gimbal, that the working state of the gimbal does not satisfy the preset condition, the lens may be controlled to be retracted.

In some exemplary embodiments, when the unmanned aerial vehicle is in the take-off state, the unmanned aerial vehicle has left the ground and has a certain flying height, to avoid interference between the lens and an obstacle below in the vertical direction in the current state of the unmanned aerial vehicle and an obstacle in the extension direction of the lens in the current state of the unmanned aerial vehicle. In this case, the distance between the unmanned aerial vehicle and the foregoing obstacle (such as the flying height of the unmanned aerial vehicle) and/or the working parameter of the gimbal may be detected; and when the distance between the unmanned aerial vehicle and the foregoing obstacle is within the preset distance range or is determined, based on the working parameter of the gimbal, that the working state of the gimbal satisfies the preset condition, the lens may be controlled to be extended; otherwise, the lens may be controlled to be retracted.

In some exemplary embodiments, when the unmanned aerial vehicle is in the aerial flying state, the unmanned aerial vehicle has left the ground and also has a flying height (the flying height is higher than the flying height in the take-off state), to avoid interference between the lens and an obstacle below in the vertical direction in the current state of the unmanned aerial vehicle and an obstacle in the extension direction of the lens in the current state of the unmanned aerial vehicle when the flying height of the unmanned aerial vehicle is too low or an obstacle such as a building exists in the flying process of the unmanned aerial vehicle. In this case, the distance between the unmanned aerial vehicle and the foregoing obstacle (such as the flying height of the unmanned aerial vehicle) and/or the working parameter of the gimbal may also be detected; and when the distance between the unmanned aerial vehicle and the foregoing obstacle is within the preset distance range or it is determined, based on the working parameter of the gimbal, that the working state of the gimbal satisfies the preset condition, the lens may be controlled to be extended; otherwise, the lens may be controlled to be retracted.

In some exemplary embodiments, when the unmanned aerial vehicle is in the returning state, it may be considered by default that the unmanned aerial vehicle has completed a photographing task, and the lens may be controlled to be retracted. Certainly, in the returning state, extension or retraction of the lens may also be controlled based on the flying height of the unmanned aerial vehicle and/or the working parameter of the gimbal, to avoid interference between extension of the lens and the obstacle or presence of a photographing requirement of optical zoom in the returning process. It may be understood that the lens may be controlled to be retracted when a return instruction is received, or the lens may be controlled to be retracted in the returning process after the return instruction is received.

Further in some exemplary embodiments, the unmanned aerial vehicle may also have a landing state, and the returning state may include the landing state. When the unmanned aerial vehicle is in the landing state, the distance between the unmanned aerial vehicle and the foregoing obstacle (such as the flying height of the unmanned aerial vehicle) and/or the working parameter of the gimbal may also be detected; and when the distance between the unmanned aerial vehicle and the foregoing obstacle is within the preset distance range or it is determined, based on the working parameter of the gimbal, that the working state of the gimbal satisfies the preset condition, the lens may be controlled to be extended; otherwise, the lens may be controlled to be retracted.

It may be understood that when the unmanned aerial vehicle is in the take-off state, the aerial flying state, the returning state, or the landing state, due to presence of an obstacle avoidance function of the unmanned aerial vehicle, the following case may seldom occur: the gimbal of the unmanned aerial vehicle directly hits an obstacle, and consequently the driving parameter of the gimbal changes. Therefore, for the working parameter of the gimbal, only the posture parameter of the gimbal may be detected, so that whether the current posture of the gimbal may cause impending interference between extension of the lens and the obstacle near the lens is determined based on the posture parameter of the gimbal, to control extension or retraction of the lens. Certainly, when the posture parameter of the gimbal is used, corresponding determining may be further performed based on the posture parameter in combination with the distance between the unmanned aerial vehicle and the foregoing obstacle.

As shown in FIG. 7, on the basis of the exemplary embodiments shown in FIG. 2, FIG. 3, FIG. 4, or FIG. 5, the method for controlling the unmanned aerial vehicle may further include: if a lens control rule for controlling the lens indicates that extension or retraction of the lens is to be controlled based on auxiliary information, controlling the extension or retraction of the lens based on the auxiliary information, where the auxiliary information may be the information for assisting in controlling the extension or retraction of the lens based on the preset trigger event.

The auxiliary information may include but is not limited to at least one of flight information of the unmanned aerial vehicle, user operation information, or environment information of the unmanned aerial vehicle. In some exemplary embodiments, the unmanned aerial vehicle may be preinstalled with a lens control rule for controlling the lens including that extension or retraction of the lens is to be controlled based on auxiliary information. In some exemplary embodiments, the lens control rule may be set before the unmanned aerial vehicle is delivered from the factory, or may be set by the user. If the lens control rule is set by the user, the lens control rule may be received during photographing or before photographing with the photographing apparatus, so that the extension or retraction of the lens is controlled according to the lens control rule. If the lens control rule is not received, the steps in FIG. 2 may be performed.

In some exemplary embodiments, a priority of a lens control manner may be configured. For example, a priority of avoiding impending interference between extension of the lens and the obstacle near the lens is the highest; next, when there is auxiliary information, extension or retraction of the lens is controlled based on the auxiliary information. In this way, more lens control requirements may be satisfied while safety of the lens is ensured as much as possible.

It may be understood that, in some exemplary embodiments, the priority of the lens control manner configured above may be that a priority of the auxiliary information is the highest, which may be set based on a requirement. However, when the lens may interfere with the obstacle near the lens, the priority of the corresponding control manner in the exemplary embodiments shown in FIG. 2, FIG. 3, FIG. 4, and FIG. 5 may be higher than that of the auxiliary information. When it is ensured that extension of the lens does not interfere with the obstacle near the lens, the priority of the corresponding control manner in the exemplary embodiments shown in FIG. 2, FIG. 3, FIG. 4, and FIG. 5 may be lower than that of the auxiliary information.

In some exemplary embodiments, the lens may have a plurality of extension lengths relative to the body. When the lens is extended, the extension length of the lens may also be controlled. The plurality of extension lengths may be a plurality of continuous extension lengths, for example, any value between about 0 cm and about 10 cm, or a plurality of discontinuous extension lengths, such as only about 2 cm, about 5 cm, or about 10 cm. The flight information of the unmanned aerial vehicle may include a speed, a speed change, and direction information of the unmanned aerial vehicle. A change of the flight information may affect resistance received by the gimbal due to the extension of the lens. Therefore, the flight information may assist in controlling the extension or retraction of the lens and the extension length. The user operation information may include control information input by the user for the unmanned aerial vehicle and/or control information input by the user for the lens. The control information for the unmanned aerial vehicle may include control information indicating returning or landing of the unmanned aerial vehicle, or the like. The control information for the lens may include control information about whether to extend the lens and the extension length of the lens or control information indicating zoom of the photographing apparatus. The user operation information may be input using a mechanical key, a voice, or a touchscreen. The user may directly control the unmanned aerial vehicle, or control the unmanned aerial vehicle indirectly using a mobile terminal. The environment information of the unmanned aerial vehicle may refer to an external environment in which the unmanned aerial vehicle is located, such as information about a wind direction, a wind speed, or a wind volume, or other weather conditions such as rain, snow, or fog.

In some exemplary embodiments, the auxiliary information may be used for assisting in determining the preset trigger event and control the extension or retraction of the lens, so that the extension or retraction and extension length of the lens may be adapted for the auxiliary information and that use performance of the unmanned aerial vehicle is improved. When the auxiliary information includes the flight information and/or the environment information, controlling the extension or retraction and extension length of the lens based on the auxiliary information may avoid excessive resistance received by the gimbal due to the excessive extension length of the lens, thereby avoiding adverse control on the gimbal, and further avoiding adverse stabilization control or adverse angle adjustment control on the photographing apparatus. When the auxiliary information includes the user operation information, controlling the extension or retraction and extension length of the lens based on the auxiliary information may further enhance human-machine interaction and enhance control of the user on the lens, so that the extension or retraction and extension length of the lens may satisfy a requirement of the user.

In some exemplary embodiments, when the auxiliary information includes the user operation information, controlling the extension or retraction of the lens based on the auxiliary information may include: if the preset trigger event does not occur, and the user operation information includes an operation for instructing the photographing apparatus to zoom, then the extension length of the lens may be controlled to satisfy a current zoom operation of the photographing apparatus. In this way, while ensuring that the lens does not interfere with the obstacle near the lens, the user may control the extension length of the lens based on the requirements of the user, and the extension length of the lens may satisfy the requirement of the user, to take photos or videos that satisfy the requirement of the user.

In some exemplary embodiments, the extension length of the lens may be the extension length adapted for the current zoom operation of the photographing apparatus. For example, if a lens length required for current optical zoom is 10 cm, the extension length of the lens is 10 cm, so that the extension length of the lens may be accurately controlled and that the extension length of the lens may be adapted to the extension length of the lens required by the user, to satisfy the photographing requirement of the user.

In some exemplary embodiments, the extension length of the lens may be greater than the extension length adapted for the current zoom operation of the photographing apparatus. The extension of the lens may require response time, and if the extension length of the lens is greater, the extension may require more time. Therefore, if the extension length of the lens is greater than the extension length adapted for the current zoom operation of the photographing apparatus, it may help save the time spent on next extension of the lens (further extension on a basis of this extension). For example, if the extension length adapted for the current zoom operation of the photographing apparatus is 5 cm, the extension length of the lens may be controlled this time to be 10 cm. This may not only satisfy a zoom requirement, but also reduce the time spent on the next extension of the lens (for example, extended to 20 cm) (because the time spent on extension from 10 cm to 20 cm is less than the time spent on extension from 5 cm to 20 cm) to satisfy a fast zoom requirement. The extension length may be less than or equal to a maximum extension length of the lens. In some exemplary embodiments, the extension length may be the maximum extension length of the lens, so that the lens may be extended in a single attempt. Therefore, while the zoom requirement is satisfied, the lens does not need to be extended again subsequently, and no time needs to be spent on further extension of the lens. Thus, a fast zoom requirement may be satisfied.

In some exemplary embodiments, it may be understood that if the current extension length of the lens is 10 cm and the user operation information indicates that the extension length of the lens required for zoom of the photographing apparatus is 5 cm, the lens may be controlled not to be retracted, that is, the extension length of the lens remains to be 10 cm, or the extension length of the lens may be controlled to decrease, for example, decrease to a value between 5 cm and 10 cm (including 5 cm).

In some exemplary embodiments, the extension length of the lens input by the user and required by the zoom operation of the photographing apparatus should be within an extension or retraction range of the lens. For example, the user may also directly input the extension length of the lens, but the extension length of the lens input by the user needs to be less than or equal to the maximum extension length of the lens.

In some exemplary embodiments, when the auxiliary information includes the user operation information, controlling the extension or retraction of the lens based on the auxiliary information may include: if the user operation information includes operation information for instructing the unmanned aerial vehicle to return or land, the lens may be controlled to be retracted. When the operation information for instructing the unmanned aerial vehicle to return or land is received, it may be considered by default that photographing of the unmanned aerial vehicle is complete. In this case, the lens may be controlled to be retracted and remain in the retracted state, or in a process of returning or landing of the lens, the lens may be controlled to be retracted and remain in the retracted state. In some exemplary embodiments, during landing of the unmanned aerial vehicle, when a distance between the lens or the unmanned aerial vehicle and the ground is less than the safe distance, that is, when the distance between the unmanned aerial vehicle and the obstacle is out of (e.g., not within) the preset distance range, the lens may be controlled to be retracted and remain in the retracted state to avoid collision between the lens and the obstacle, and especially to avoid collision with the ground when the distance between the lens and the ground is short. In this way, when the user triggers one-key landing or one-key returning, the lens may be retracted, to limit a wide-range optical zoom function.

In some exemplary embodiments, when the auxiliary information includes the flight information, controlling the extension or retraction of the lens based on the auxiliary information may include: if the preset trigger event does not occur, and the flight information indicates that the unmanned aerial vehicle is in a turning state and/or an acceleration state, the extension length of the lens may be controlled to be a first preset length. In the flying process of the unmanned aerial vehicle, when the unmanned aerial vehicle is in the turning state and/or the acceleration state, an excessive extension length of the lens increases resistance to motion of the unmanned aerial vehicle or the gimbal. Therefore, to avoid a resistance problem caused by the excessive extension length of the lens, and to effectively solve the optical zoom requirement of the photographing apparatus, the extension length of the lens may be controlled to be the first preset length, where the first preset length may be less than the maximum extension length of the lens.

In some exemplary embodiments, if the flight information includes turning information of the unmanned aerial vehicle, when it is determined, based on the turning information, that the unmanned aerial vehicle may be in the turning state, the extension length of the lens may be controlled to be the first preset length; otherwise, the corresponding steps may be performed in the manner as in the exemplary embodiments shown in FIG. 2. If the flight information includes acceleration information of the unmanned aerial vehicle, when it is determined, based on the acceleration information, that the unmanned aerial vehicle may be in the acceleration state, the extension length of the lens may be controlled to be the first preset length; otherwise, the corresponding steps may be performed in the manner as in the exemplary embodiments shown in FIG. 2. If the flight information includes turning information and acceleration information of the unmanned aerial vehicle, when it is determined, based on the turning information, that the unmanned aerial vehicle is may be the turning state or that the unmanned aerial vehicle may be in the acceleration state, the extension length of the lens may be controlled to be the first preset length; otherwise, the corresponding steps may be performed in the manner as in First exemplary embodiments the exemplary embodiments shown in FIG. 2.

In some exemplary embodiments, when the preset trigger event does not occur and the unmanned aerial vehicle is in the turning state and/or the acceleration state, controlling the extension length of the lens to be the first preset length may include the following cases:

In some exemplary embodiments, the lens may currently be in the completely retracted state. In this case, if there is no high-magnification optical zoom requirement, the current state of the lens may be maintained, that is, the extension length of the lens may be zero. If there is a high-magnification optical zoom requirement, the extension length of the lens may be controlled to satisfy a current optical zoom requirement.

In some exemplary embodiments, the lens may currently be in the partially retracted state, that is, the lens is extended, but the extension length may be less than the maximum extension length. In this case, if there is no high-magnification optical zoom requirement, the current state of the lens may be maintained, and the extension length of the lens may be controlled to decrease relative to the current extension length, or the lens may be completely retracted, that is, the extension length of the lens may be zero. If there is a high-magnification optical zoom requirement, the extension length of the lens may be controlled to satisfy a current optical zoom requirement.

In some exemplary embodiments, the lens may currently be in the completely extended state, that is, the extension length of the lens may be at the maximum extension length. In this case, if there is no high-magnification optical zoom requirement, the extension length of the lens may be controlled to decrease relative to the current extension length, or the lens may be completely retracted, that is, the extension length of the lens may be zero. If there is a high-magnification optical zoom requirement, the extension length of the lens may be controlled to satisfy a current optical zoom requirement.

In this way, when the unmanned aerial vehicle is in the turning state and/or the acceleration state, controlling the extension length of the lens may reduce adverse resistance received in a control process of the unmanned aerial vehicle or the gimbal due to a reason of the extension length of the lens, may help control the gimbal, and may avoid excessive energy consumption of the motor, which may shorten the service life of the motor.

It may be understood that in the exemplary embodiments, if the preset trigger event occurs, regardless of whether the unmanned aerial vehicle is currently in the turning state and/or the acceleration state, the lens may be controlled to be in the retracted state, that is, the extension or retraction of the lens may be controlled according to logic of occurrence of the preset trigger event.

In some exemplary embodiments, when the auxiliary information includes the environment information, the extension or retraction of the lens may be controlled based on the auxiliary information include: when the preset trigger event does not occur, and the environment information indicates that a current wind speed of the environment in which the unmanned aerial vehicle is located is greater than a preset wind speed and/or that an angle between the wind direction and the extension direction of the lens is greater than a preset angle, the extension length of the lens may be controlled to be a second preset length. In the flying process of the unmanned aerial vehicle, the unmanned aerial vehicle may encounter some relatively severe environments, for example, the wind speed may be too high, or the wind direction may be opposite to a current flight direction of the unmanned aerial vehicle. These environment factors may all be disadvantageous for flight control of the unmanned aerial vehicle. Excessive extension of the lens also increases the resistance received by the unmanned aerial vehicle or gimbal in the moving process. Therefore, to avoid an increased resistance caused by the excessive extension length of the lens, and effectively solve the optical zoom requirement of the photographing apparatus, the extension length of the lens may be controlled to be the second preset length, where the second preset length may be less than the maximum extension length of the lens.

In some exemplary embodiments, if the environment information includes wind speed information, when it is determined, based on the wind speed information, that the current wind speed is greater than the preset wind speed, the extension length of the lens may be controlled to be the second preset length; otherwise, the corresponding steps may be performed in the manner as in the exemplary embodiments shown in FIG. 2. If the environment information includes wind direction information, when it is determined, based on the wind direction information, that the angle between the wind direction and the extension direction of the lens is greater than the preset angle, the extension length of the lens may be controlled to be the second preset length; otherwise, the corresponding steps may be performed in the manner as in the exemplary embodiments shown in FIG. 2. If the environment information includes wind speed information and wind direction information, when it is determined, based on the wind speed information, that the current wind speed is greater than the preset wind speed, or it is determined, based on the wind direction information, that the angle between the wind direction and the extension direction of the lens is greater than the preset angle, the extension length of the lens may be controlled to be the second preset length; otherwise, the corresponding steps may be performed in the manner as in the exemplary embodiments shown in FIG. 2.

In some exemplary embodiments, when the preset trigger event does not occur, and the wind speed is greater than the preset wind speed and/or the angle between the wind direction and the extension direction of the lens is greater than the preset angle, the extension length of the lens may be controlled to be the second preset length may include the following cases:

In some exemplary embodiments, the lens may currently be in the completely retracted state. In this case, if there is no high-magnification optical zoom requirement, the current state of the lens may be maintained, that is, the extension length of the lens may be zero. If there is a high-magnification optical zoom requirement, the extension length of the lens may be controlled to satisfy a current optical zoom requirement.

In some exemplary embodiments, the lens may currently be in the partially retracted state, that is, the lens may be extended, but the extension length may be less than the maximum extension length. In this case, if there is no high-magnification optical zoom requirement, the current state of the lens may be maintained, and the extension length of the lens may be controlled to decrease relative to the current extension length, or the lens may be completely retracted, that is, the extension length of the lens is zero. If there is a high-magnification optical zoom requirement, the extension length of the lens may be controlled to satisfy a current optical zoom requirement.

In some exemplary embodiments, the lens may currently be in the completely extended state, that is, the extension length of the lens may be at the maximum extension length. In this case, if there is no high-magnification optical zoom requirement, the extension length of the lens may be controlled to decrease relative to the current extension length, or the lens may be completely retracted, that is, the extension length of the lens is zero. If there is a high-magnification optical zoom requirement, the extension length of the lens may be controlled to satisfy a current optical zoom requirement.

In this way, when the wind speed is greater than the preset wind speed and/or the angle between the wind direction and the extension direction of the lens is greater than the preset angle, controlling the extension length of the lens may reduce adverse resistance received in a control process of the unmanned aerial vehicle or the gimbal due to a reason of the extension length of the lens, help control the gimbal, and avoid excessive energy consumption of the motor, which may otherwise shorten the service life of the motor.

It may be understood that in some exemplary embodiments, if the preset trigger event occurs, regardless of whether the current wind speed is greater than the preset wind speed and/or the angle between the wind direction and the extension direction of the lens is greater than the preset angle, the lens may be controlled to be in the retracted state, that is, the extension or retraction of the lens is controlled according to logic of occurrence of the preset trigger event.

Further in some exemplary embodiments, when the auxiliary information includes a plurality of pieces of information, when the extension or retraction of the lens may be controlled based on the flight information, the user operation information, or the environment information of the unmanned aerial vehicle, a priority of the user operation information may be the highest, that is, when at least one of the flight information or the environment information of the unmanned aerial vehicle coexists with the user operation information, the lens may be extended or retracted preferentially based on the user operation information, so that the extension length of the lens satisfies the photographing requirement of the user. For example, if the lens needs to be controlled to be retracted based on the current flight information, but the lens needs to be controlled to be extended based on the user operation information, the lens may be controlled to be extended.

As shown in the exemplary embodiments of FIG. 6, based on the foregoing method for controlling the unmanned aerial vehicle, in some exemplary embodiments according to the present disclosure further provides a control apparatus, including a memory 200 and a processor 300. The method in the embodiment of the present disclosure may be implemented by one or more processors 300. In some exemplary embodiments, the processor 300 may be an independent processor that communicates with a flight controller of the unmanned aerial vehicle, or may be a flight processor disposed in the unmanned aerial vehicle, or may be an intelligent mobile terminal configured to control flight of the unmanned aerial vehicle.

In some exemplary embodiments, the memory 200 may be configured to store a program code. The processor 300 may be configured to invoke the program code to perform the following: detecting whether a preset trigger event for determining impending interference between a lens and an obstacle near the lens occurs; and if no, controlling the lens to be in an extended state; or if yes, controlling the lens to be in a retracted state, to avoid interference between extension of the lens and the obstacle.

In some exemplary embodiments, the obstacle may include an obstacle below in a vertical direction in a current state of the unmanned aerial vehicle; and/or the obstacle may include an obstacle in an extension direction of the lens in a current state of the unmanned aerial vehicle.

In some exemplary embodiments, the processor 300 may be configured to: obtain a distance information between the unmanned aerial vehicle and the obstacle, and/or obtain a working parameter of a gimbal mounted on the unmanned aerial vehicle, where the gimbal may be configured to carry a photographing apparatus; and detect, based on the distance information and/or the working parameter, whether the preset trigger event occurs.

In some exemplary embodiments, the processor 300 may be further configured to: detect, based on the distance information, whether a distance between the unmanned aerial vehicle and the obstacle is within a preset distance range; and if the distance is out of (e.g., not within) the preset distance range, determine that the preset trigger event occurs. In some exemplary embodiments, a current state of the unmanned aerial vehicle may be a flying state or a returning state.

In some exemplary embodiments, the processor 300 may be configured to: detect, based on the working parameter, whether a current working state of the gimbal satisfies a preset condition; and if the current working state does not satisfy the preset condition, determine that the preset trigger event occurs. In some exemplary embodiments, a current state of the unmanned aerial vehicle is a take-off-ready state (i.e., ready-to-take-off state).

In some exemplary embodiments, the processor 300 may be configured to: detect, based on the distance information, whether a distance between the unmanned aerial vehicle and the obstacle is within a preset distance range, and detect, based on the working parameter, whether a current working state of the gimbal satisfies a preset condition; and if the distance is out of the preset distance range (e.g., not within the preset distance range), and the current working state does not satisfy the preset condition, determine that the preset trigger event occurs.

In some exemplary embodiments, the working parameter may include a posture parameter of the gimbal and/or a driving parameter of a driving apparatus of the gimbal.

In some exemplary embodiments, the driving apparatus may include a motor, and the driving parameter may include a current of the motor and/or an output torque of the motor.

In some exemplary embodiments, the processor 300 may be configured to: detect, based on the posture parameter of the gimbal, whether a current posture of the gimbal is a preset posture; and if the current posture is not the preset posture, determine that the current working state does not satisfy the preset condition. In some exemplary embodiments, a current state of the unmanned aerial vehicle is a flying state or a returning state.

In some exemplary embodiments, the processor 300 is configured to: detect whether the driving parameter is within a preset parameter range; and if the driving parameter is not within the preset parameter range, determine that the current working state does not satisfy the preset parameter range.

In some exemplary embodiments, the processor 300 may be configured to: detect, based on the posture parameter of the gimbal, whether a current posture of the gimbal is a preset posture, and detect whether the driving parameter is within a preset parameter range; and if the current posture is not the preset posture, and the driving parameter is not within the preset parameter range, determine that the current working state does not satisfy the preset condition.

In some exemplary embodiments, the preset posture may be a posture corresponding to a pitch axis.

In some exemplary embodiments, the processor 300 may be configured to: detect whether the current of the motor is less than a preset current; and if the current of the motor is not less than the preset current, determine that the driving parameter is not within the preset parameter range.

In some exemplary embodiments, the processor 300 may be configured to: detect whether the output torque of the motor is less than a preset output torque; and if the output torque of the motor is not less than the preset output torque, determine that the driving parameter is not within the preset parameter range.

In some exemplary embodiments, the processor 300 may be configured to: detect whether a propeller of the unmanned aerial vehicle rotates; and if the propeller rotates, perform the step of detecting, based on the distance information, whether a distance between the unmanned aerial vehicle and the obstacle is within a preset distance range.

In some exemplary embodiments, the processor 300 may be configured to: if the propeller does not rotate, control the lens to be in the retracted state.

In some exemplary embodiments, the processor 300 may be configured to: if a lens control rule for controlling the lens indicates that extension or retraction of the lens may be controlled based on auxiliary information, control the extension or retraction of the lens based on the auxiliary information, where the auxiliary information may be an information for assisting in controlling the extension or retraction of the lens based on the preset trigger event.

In some exemplary embodiments, the auxiliary information may include at least one of flight information of the unmanned aerial vehicle, user operation information, or environment information of the unmanned aerial vehicle.

In some exemplary embodiments, user operation information in the auxiliary information may have the highest priority.

In some exemplary embodiments, the processor 300 may be configured to: when the auxiliary information includes the user operation information, if the user operation information includes operation information for instructing the unmanned aerial vehicle to return or land, control the lens to be in the retracted state.

In some exemplary embodiments, the lens may have a plurality of extension lengths relative to a body, and the processor 300 may be configured to: when the auxiliary information includes the user operation information, if the preset trigger event does not occur, and a user operation includes an operation for instructing the photographing apparatus to zoom, control an extension length of the lens to satisfy a current zoom operation of the photographing apparatus. In some exemplary embodiments, the extension length of the lens may be an extension length adapted for the current zoom operation of the photographing apparatus. In some exemplary embodiments, the extension length of the lens may be greater than an extension length adapted for the current zoom operation of the photographing apparatus. In some exemplary embodiments, the extension length of the lens may be a maximum extension length of the lens.

In some exemplary embodiments, the processor 300 may be configured to: when the auxiliary information includes the flight information, if the preset trigger event does not occur, and the flight information indicates that the unmanned aerial vehicle is in a turning state and/or an acceleration state, control an extension length of the lens to be a first preset length, where the first preset length is less than a maximum extension length of the lens.

In some exemplary embodiments, the processor 300 may be configured to: when the auxiliary information includes the environment information, when the preset trigger event does not occur, and the environment information indicates that a current wind speed of an environment in which the unmanned aerial vehicle is located is greater than a preset wind speed and/or that an angle between a wind direction and the extension direction of the lens is greater than a preset angle, control an extension length of the lens to be a second preset length, where the second preset length is less than a maximum extension length of the lens.

In some exemplary embodiments, the control apparatus may be a general-purpose computer or a special purpose computer, both may be used to implement an on-demand system for the present disclosure. The control apparatus may be used to implement any component of the on-demand service as described herein. Although only one such computer is shown, for convenience, the computer functions relating to the on-demand service as described herein may be implemented in a distributed fashion on a number of similar platforms, to distribute the processing load.

The control apparatus, for example, may include COM ports connected to and from a network connected thereto to facilitate data communications. The control apparatus may also include a central processing unit (CPU), in the form of one or more processors, for executing program instructions. The exemplary computer platform may include an internal communication bus, program storage and data storage of different forms, for example, a disk, and a read-only memory (ROM), or random-access memory (RAM), for various data files to be processed and/or transmitted by the computer. The exemplary computer platform may also include program instructions stored in the ROM, RAM, and/or other type of non-transitory storage medium to be executed by the CPU. The methods and/or processes of the present disclosure may be implemented as the program instructions. The control apparatus also includes an I/O component, supporting input/output between the computer and other components therein such as user interface elements. The control apparatus may also receive programming and data via network communications.

Merely for illustration, only one CPU and/or processor is described in the control apparatus. However, it should be note that the control apparatus in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the control apparatus executes both step A and step B, it should be understood that step A and step B may also be performed by two different CPUs and/or processors jointly or separately in the control apparatus (e.g., the first processor executes step A and the second processor executes step B, or the first and second processors jointly execute steps A and B).

The present disclosure further provides an unmanned aerial vehicle, including the control apparatus in any one of the foregoing exemplary embodiments.

As shown in FIG. 7 according to some exemplary embodiments of the present disclosure, the unmanned aerial vehicle may include a body 118, a propeller 106 disposed on the body 118, a gimbal 102 disposed on the body 118, and a load fixed on the gimbal 102, such as a photographing apparatus 104. The unmanned aerial vehicle may further include a controller 108 and a sensing system 110. The sensing system 110 obtains a signal, and sends the signal to the controller 108, and the controller 108 performs corresponding control on the unmanned aerial vehicle based on the received signal. The sensing system 110 may include a ranging sensor, a wind direction sensor, and the like. In some exemplary embodiments, the ranging sensor may detect distance information between the unmanned aerial vehicle and an obstacle, and may send the distance information to the controller, and the controller may control the extension or retraction of a lens based on the distance information.

For example, the sensing system 110 may detect whether a preset trigger event for determining impending interference between the lens and an obstacle near the lens occurs, and may send a detection result to the controller 108; and the controller 108 may control the extension or retraction of the lens of the photographing apparatus 101 based on the detection result. In some exemplary embodiments, when the preset trigger event does not occur, the controller 108 may control the lens to be in an extended state; or when the preset trigger event occurs, the controller 108 may control the lens to be in a retracted state, to avoid interference between the extension of the lens and the obstacle.

The unmanned aerial vehicle may be communicatively connected to a terminal 112. In some exemplary embodiments, the terminal 112 may provide control data to one or more of the unmanned aerial vehicle, the gimbal 102, and the photographing apparatus 104, and receive information (such as location and/or motion information of the unmanned aerial vehicle and the gimbal 102, and data sensed by the photographing apparatus 104, such as captured image data) from one or more of the unmanned aerial vehicle, the gimbal 102, and the photographing apparatus 104.

In some exemplary embodiments, the unmanned aerial vehicle may communicate with other remote devices than the terminal 112, and the terminal 112 may also communicate with other remote devices than the unmanned aerial vehicle. For example, the unmanned aerial vehicle and/or the terminal 112 may communicate with another unmanned aerial vehicle or a gimbal or load on another unmanned aerial vehicle. When necessary, the other remote device may be another terminal or a computing device other than the terminal 112.

In some exemplary embodiments, flight of the unmanned aerial vehicle, motion of the gimbal 102, motion of the photographing apparatus 104 relative to a fixed reference object (such as an external environment), and/or motion between each other, and/or execution of corresponding functions, for example, a zoom operation of the photographing apparatus 104, may be controlled by the terminal 112. The terminal 112 may be a remote control terminal, which is located far away from the unmanned aerial vehicle, the gimbal 102 and/or the photographing apparatus 104. The terminal 112 may be located or bonded on a supporting platform. In some exemplary embodiments, the terminal 112 may be handheld or wearable. The terminal 112 may include a user interface, such as a keyboard, a mouse, a joystick, a touchscreen, or a display. Any appropriate user input may interact with the terminal 112, such as manual input of an instruction, voice control, gesture control, or position control (for example, through motion, position, or tilt of the terminal 112).

In some exemplary embodiments, for the unmanned aerial vehicle used for aerial photographing, controlling the extension or retraction of the lens of the photographing apparatus 104 not only helps satisfy more photographing requirements and achieve portability and compactness of the unmanned aerial vehicle, but also helps reduce a damage rate of the lens and prolong the service life of the lens correspondingly. In addition, controlling the extension or retraction of the lens, and especially controlling the extension or retraction of the lens with a great extension length may reduce the resistance and jitter caused by unnecessary extension or retraction of the lens. This is advantageous for posture control of the gimbal 102 or the unmanned aerial vehicle.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit. When the integrated unit is implemented in the form of a software functional unit and sold or used as an independent product, the integrated unit may be stored in a computer-readable storage medium. Based on such an understanding, the technical solutions of the present disclosure essentially, or the part contributing to the conventional technique, or all or a part of the technical solutions may be implemented in the form of a software product. The computer software product is stored in a storage medium and may include several instructions for instructing a computer processor (processor) to perform all or a part of the steps of the methods described in the embodiments of the present disclosure. The foregoing storage medium may include any medium that may store program code, such as a USB flash drive, a removable hard disk, a read-only memory (ROM, Read-Only Memory), a random access memory (RAM, Random Access Memory), a magnetic disk, or an optical disc.

As described above, the method for controlling the unmanned aerial vehicle according to the embodiments of the present disclosure may enable the unmanned aerial vehicle to have a more compact structure, a smaller volume, and better portability, while ensuring an optical zoom function.

In present disclosure, unless otherwise explicitly specified and defined, the term “plurality” indicates two or more; and unless otherwise specified and defined, the terms “connection” and “fixing” should be understood in general senses. For example, the “connection” may be a fixed connection, a detachable connection, an integrated connection, or an electrical connection; or may be a direct connection, or an indirect connection through an intermediate medium. A person of ordinary skill in the art may understand specific meanings of these terms in the present disclosure based on specific situations.

In present disclosure, it needs to be understood that directions or position relationships indicated by terms “up”, “down”, “front”, “rear”, “left”, and “right” are directions or position relationships based on the accompanying drawings, and are used only for conveniently describing the present disclosure and simplifying the descriptions, but do not indicate or imply that a mentioned apparatus or unit must have a specific direction and must be constructed and operated in a specific direction, and therefore cannot be understood as limitations on the present disclosure.

In present disclosure, the description of the terms “one embodiment”, “some exemplary embodiments”, “specific embodiments”, and the like means that specific features, structures, materials, or characteristics described with reference to the embodiment(s) or example(s) are included in at least one embodiment or example of the present disclosure. In this specification, a schematic representation of the foregoing terms does not necessarily refer to a same embodiment or a same example. In addition, the described specific features, structures, materials, or characteristics may be combined in one or more embodiments or examples in an appropriate manner.

The foregoing descriptions are only preferred embodiments of the present disclosure, and are not intended to limit the present disclosure. For a person skilled in the art, the present disclosure may be subject to various changes and variations. Any modifications, equivalent replacements, improvements, and the like made within the spirit and principle of the present disclosure shall fall within the protection scope of the present disclosure.

What is claimed is:

1. A method for controlling an unmanned aerial vehicle, comprising:
determining whether a preset trigger event indicating impending interference between a lens of a photographing apparatus and an obstacle near the lens occurs, the photographing apparatus being disposed on a body of the unmanned aerial vehicle; and
controlling the lens to be in an extended state in response to a determining that the preset trigger event does not occur; or
controlling the lens to be in a retracted state, to avoid the lens from interfering with the obstacle, in response to a determining that the preset trigger event occurs.

2. The method according to claim 1, wherein the obstacle includes at least one of:
an obstacle directly below the unmanned aerial vehicle, or
an obstacle in an extension direction of the lens.

3. The method according to claim 1, wherein the determining of whether the preset trigger event occurs includes:
obtaining at least one of:
distance information between the unmanned aerial vehicle and the obstacle, or
a working parameter of a gimbal that is mounted on the unmanned aerial vehicle, wherein the gimbal is configured to carry the photographing apparatus, and
determining whether the preset trigger event occurs based on at least one of the at least one of the distance information or the working parameter.

4. The method according to claim 3, wherein the determining of whether the preset trigger event occurs includes at least one of:
determining, based on the distance information, whether a distance between the unmanned aerial vehicle and the obstacle is within a preset distance range, and then determining that the preset trigger event occurs, or
determining, based on the working parameter, whether a current working state of the gimbal satisfies a preset condition, and then determining that the preset trigger event occurs.

5. The method according to claim 4, wherein the working parameter includes a posture parameter of the gimbal or a driving parameter of a driving apparatus of the gimbal.

6. The method according to claim 5, wherein the driving apparatus includes a motor, and the driving parameter includes a current passing through the motor or an output torque of the motor.

7. The method according to claim 6, wherein the determining of whether a current working state of the gimbal satisfies the preset condition includes at least one of:
determining, based on the posture parameter of the gimbal, that when the current posture is not the preset posture, and then determining that the current working state does not satisfy the preset condition; or
determining, based on the working parameter, that whether the driving parameter is within a preset parameter range, and then determining that the current working state does not satisfy the preset condition.

8. The method according to claim 7, wherein the preset posture is a posture corresponding to a pitch axis of the gimbal.

9. The method according to claim 7, wherein the determining of whether the driving parameter is within a preset parameter range includes at least one of:
determining that the current of the motor is greater than or equal to the preset current, and then determining that the driving parameter is not within the preset parameter range; or
determining the output torque of the motor is not less the preset output torque, and then determining that the driving parameter is not within the preset parameter range.

10. The method according to claim 4, wherein a current state of the unmanned aerial vehicle is a take-off-ready state.

11. The method according to claim 4, wherein a current state of the unmanned aerial vehicle is a flying state or a returning state.

12. The method according to claim 4 further comprising:
determining that a propeller of the unmanned aerial vehicle rotates, and then determining, based on the distance information, whether a distance between the unmanned aerial vehicle and the obstacle is within a preset distance range; or
determining that the propeller does not rotate, and then controlling the lens to be in the retracted state.

13. The method according to claim 12, further comprising:
controlling the extension or retraction of the lens based on auxiliary information, wherein the auxiliary information is information for assisting in controlling the extension or retraction of the lens based on the preset trigger event.

14. The method according to claim 13, wherein the auxiliary information includes at least one of flight information of the unmanned aerial vehicle, user operation information, or environment information of the unmanned aerial vehicle.

15. The method according to claim 14, wherein user operation information in the auxiliary information has the highest priority.

16. The method according to claim 14, wherein:
when the auxiliary information includes the user operation information, the controlling of the extension or retraction of the lens based on the auxiliary information includes: controlling the lens to be in the retracted state, if the user operation information includes operation information for instructing the unmanned aerial vehicle to return or land;
wherein the lens has a plurality of extension lengths relative to the body, and the auxiliary information includes the user operation information, the controlling the extension or retraction of the lens based on the auxiliary information includes: controlling an extension length of the lens to satisfy a current zoom operation of the photographing apparatus, if
the preset trigger event does not occur, and the user operation information includes an operation for instructing the photographing apparatus to zoom;
wherein when the auxiliary information includes the flight information, the controlling of the extension or retraction of the lens based on the auxiliary information includes: controlling an extension length of the lens to be a first preset length, if
the preset trigger event does not occur, and the flight information indicates that the unmanned aerial vehicle is in at least one of a turning state or an acceleration state, wherein the first preset length is less than a maximum extension length of the lens; and
wherein when the auxiliary information includes the environment information, the controlling of the extension or retraction of the lens based on the auxiliary information includes: controlling an extension length of the lens to be a second preset length, when
the preset trigger event does not occur, and
the environment information indicates at least one of:
that a current wind speed of an environment in which the unmanned aerial vehicle is located is greater than a preset wind speed, or
that an angle between the wind direction and the extension direction of the lens is greater than a preset angle,
wherein the second preset length is less than a maximum extension length of the lens.

17. The method according to claim 16, wherein the extension length of the lens is greater than or equal to an extension length adapted for the current zoom operation of the photographing apparatus.

18. The method according to claim 17, wherein the extension length of the lens is a maximum extension length of the lens.

19. A control apparatus for an unmanned aerial vehicle having a body, a photographing apparatus located on the body; and a lens of the photographing apparatus extendable and retractable relative to the body, comprising:
at least one storage medium, storing at least one set of instructions for controlling the unmanned aerial vehicle; and
at least one processor in communication with the at least one storage medium, wherein during operation, the at least one processor executes the at least one set of instructions to:
determine whether a preset trigger event for determining impending interference between the lens and an obstacle near the lens occurs; and
control the lens to be in an extended state in response to a determination that the preset trigger event does not occur; or
control the lens to be in a retracted state, to avoid interference between extension of the lens and the obstacle, in response to a determination that the preset trigger event occurs.

20. An unmanned aerial vehicle, comprising:
a body;
a photographing apparatus located on the body;
a lens of the photographing apparatus extendable and retractable relative to the body; and
a control apparatus, including:
at least one storage medium, storing at least one set of instructions for controlling the unmanned aerial vehicle; and
at least one processor in communication with the at least one storage medium, wherein during operation, the at least one processor executes the at least one set of instructions to:
determine whether a preset trigger event for determining impending interference between the lens and an obstacle near the lens occurs; and
control the lens to be in an extended state in response to a determination that the preset trigger event does not occur; or
control the lens to be in a retracted state, to avoid interference between extension of the lens and the obstacle, in response to a determination that the preset trigger event occurs.
